(19) United States
(12) Patent Application Publication
(10) Pub. No.: US 2013/0264779 A1
(43) Pub. Date: Oct. 10, 2013

(54) SEGMENTED INTERSTAGE SEAL SYSTEM

(71) Applicant: Matthew Troy Hafner, Honea Path, SC (US)

(72) Inventor: Matthew Troy Hafner, Honea Path, SC (US)

(73) Assignee: General Electric Company, Schenectady, NY (US)

(21) Appl. No.: 13/443,693

(22) Filed: Apr. 10, 2012

(51) Int. Cl. F16J 15/02

(52) U.S. Cl. 277/641; 277/628; 277/650

(57) ABSTRACT

A system includes an interstage seal system. The interstage seal system extends axially between a first rotor wheel of a first turbine stage of a multi-stage turbine and a second rotor wheel of a second turbine stage of the multi-stage turbine. The interstage seal system has an interstage seal and at least one coverplate. The interstage seal is configured to wedge axially between the at least one coverplate and the first or second rotor wheel.

### BACKGROUND OF THE INVENTION

The subject matter disclosed herein relates to gas turbines, and more specifically, to interstage seals within gas turbines.

In general, gas turbine engines combust a mixture of compressed air and fuel to produce hot combustion gases. The combustion gases may flow through one or more turbine stages to generate power for a load and/or compressor. A pressure drop may occur between stages, which may allow leakage flow of a fluid, such as combustion gases, through unintended paths. Seals may be disposed between the stages to reduce fluid leakage between the stages. Unfortunately, the seals may not be field maintainable, or a substantial amount of work may be required to replace the seals in the field. In addition, the shape of the seals may make access to internal components of the turbine more difficult. Furthermore, the seals may require additional components, such as spacers, to ensure proper axial and radial alignment of the seals.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a multi-stage turbine. The multi-stage turbine has an interstage seal system extending axially between a first turbine stage of the multi-stage turbine and a second turbine stage of the multi-stage turbine. The interstage seal system has an interstage seal, a forward coverplate, and an aft coverplate. The forward coverplate is disposed axially between a first rotor wheel of the first turbine stage and the interstage seal. The after coverplate is disposed axially between the interstage seal and a second rotor wheel of the second turbine stage. The interstage seal is configured to wedge axially between the forward and aft coverplates.

In accordance with a second embodiment, a system includes an interstage seal system. The interstage seal system extends axially between a first rotor wheel of a first turbine stage of a multi-stage turbine and a second rotor wheel of a second turbine stage of the multi-stage turbine. The interstage seal system has an interstage seal and at least one coverplate. The interstage seal is configured to wedge axially between the at least one coverplate and the first or second rotor wheel.

In accordance with a third embodiment, a system includes a multi-stage turbine. The multi-stage turbine has an interstage seal system extending axially between a first turbine stage of the multi-stage turbine and a second turbine stage of the multi-stage turbine. The interstage seal system has an interstage seal seal, a forward coverplate, and an aft coverplate. The interstage seal has a T-shaped upper body with a generally rectangular seal portion that extends generally parallel to a shaft of the multi-stage turbine. The forward coverplate is disposed axially between a first rotor wheel of the first turbine stage and the interstage seal. The forward coverplate has a T-shaped upper body with a generally rectangular seal portion that extends generally parallel to the shaft of the multi-stage turbine. The after coverplate is disposed axially between the interstage seal and a second rotor wheel of the second turbine stage. The aft coverplate also has a T-shaped upper body with a generally rectangular seal portion that extends generally parallel to the shaft of the multi-stage turbine. The interstage seal is configured to wedge axially between the forward and aft coverplates.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a gas turbine engine that may employ turbine seals in accordance with aspects of the present techniques;

FIG. 2 is a cross-sectional side view of an embodiment of the gas turbine engine of FIG. 1 taken along a longitudinal axis in accordance with aspects of the present techniques;

FIG. 3 is a partial cross-sectional side view of the gas turbine engine of FIG. 2 illustrating an embodiment of an interstage seal system between turbine stages in accordance with aspects of the present techniques;

FIG. 4 is a view of the interstage seal system of FIG. 3 along the longitudinal axis illustrating an embodiment of an upper sealing region in accordance with aspects of the present techniques;

FIG. 5 is a partial cross sectional view of the gas turbine engine of FIG. 2 illustrating an embodiment of an interstage seal system between turbine stages in accordance with aspects of the present techniques; and

FIG. 6 is a side view of an embodiment of circumferentially adjacent interstage seal systems in accordance with aspects of the present techniques.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the—” and “said” are intended to mean that there are one or more of the elements. The terms “comprising,” “including,” and “having” are intended to be inclusive and mean that there may be additional elements other than the listed elements.

The present disclosure is directed to interstage turbine seal systems that may be employed to reduce fluid leakage between stages of a turbine. The interstage seal system includes features to seal an interstage gap without the use of additional components, such as spacer wheels. In certain embodiments, the interstage seal system may be entirely supported by the rotors of the turbine without a mid-rotor support. The interstage seal system includes multiple axial components that are designed to wedge against each other between adjacent turbine stages. The wedged surfaces formed between the multiple axial components reduce the likelihood or magnitude of axial or radial displacement of the interstage seal system. Furthermore, the axial components of the interstage seal system may be field maintainable and field replaceable.

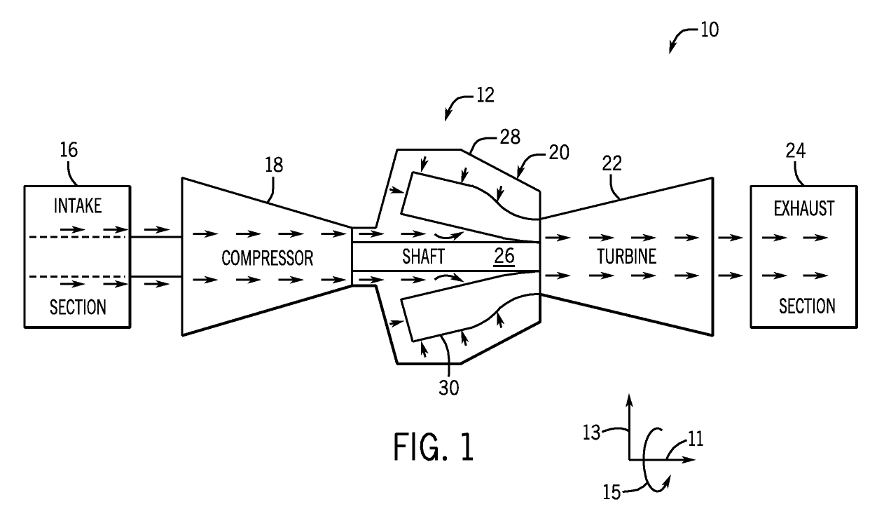

FIG. 1 is a block diagram of an exemplary system 10 including a gas turbine engine 12 that may employ interstage seals as described in detail below. In certain embodiments, the system 10 may include an aircraft, a watercraft, a locomotive, a power generation system, or combinations thereof. The illustrated gas turbine engine 12 includes an air intake section 16, a compressor 18, a combustor section 20, a turbine 22, and an exhaust section 24. The turbine 22 is coupled to the compressor 18 via a shaft 26.

As indicated by the arrows, air may enter the gas turbine engine 12 through the intake section 16 and flow into the compressor 18, which compresses the air prior to entry into the combustor section 20. The illustrated combustor section 20 includes a combustor housing 28 disposed concentrically or annularly about the shaft 26 between the compressor 18 and the turbine 22. The compressed air from the compressor 18 enters combustors 30, where the compressed air may mix and combust with fuel within the combustors 30 to drive the turbine 22.

From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24. As discussed below, the turbine 22 may include a plurality of interstage seal systems, which may reduce the leakage of hot combustion gasses between stages of the turbine 22, and reduce the spacing between rotating components of the turbine 22, such as rotor wheels. Throughout the discussion presented herein, a set of axes will be referenced. These axes are based on a cylindrical coordinate system and point in an axial direction 11 (e.g. longitudinal), a radial direction 13, and a circumferential direction 15. Further, the terms “first” and “second” may be applied to elements of the system 10 to distinguish between repeated instances of an element. These terms are not intended to impose a serial or temporal limitation to the corresponding elements.

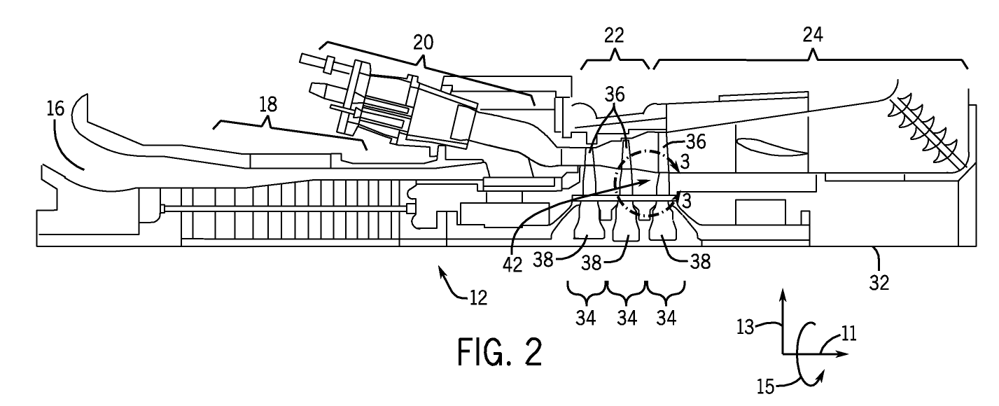

FIG. 2 is a cross-sectional side view of an embodiment of the gas turbine engine 12 of FIG. 1 taken along a longitudinal axis 32. As depicted, the gas turbine 22 includes three separate stages 34; however, the gas turbine 22 may include any number of stages 34. Each stage 34 includes a set of blades 36 coupled to a rotor wheel 38 that may be rotatably attached to the shaft 26 (FIG. 1). The blades 36 extend radially outward from the rotor wheels 38 and are partially disposed within the path of the hot combustion gases through the turbine 22. As described in greater detail below, interstage seal systems 42 extend between the stages 34 and are supported by adjacent rotor wheels 38. The interstage seals systems 42 may include multiple axial components that wedge against each other. Accordingly, the interstage seal systems 42 may be designed to be field maintainable and field replaceable. In addition, the interstage seal systems 42 may provide for improved cooling of the stages 34. Although the gas turbine 22 is illustrated in FIG. 2 as a three-stage turbine, the interstage seal systems 42 described herein may be employed in any suitable type of turbine with any number of stages and shafts. For example, the interstage seal systems 42 may be included in a single turbine system, in a dual turbine system that includes a low-pressure turbine and a high-pressure turbine, or in a steam turbine. Further, the interstage seals 42 described herein may also be employed in a rotary compressor, such as the compressor 18 illustrated in FIG. 1. The interstage seals 42 may be made from various high-temperature alloys, such as, but not limited to, nickel based alloys.

As described above with respect to FIG. 1, air enters through the air intake section 16 and is compressed by the compressor 18. The compressed air from the compressor 18 is then directed into the combustor section 20 where the compressed air is mixed with fuel. The mixture of compressed air and fuel is generally burned within the combustor section 20 to generate high-temperature, high-pressure combustion gases, which are used to generate torque within the turbine 22. Specifically, the combustion gases apply motive forces to the blades 36 to turn the rotor wheels 38. In certain embodiments, a pressure drop may occur at each stage 34 of the turbine 22, which may allow gas leakage flow through unintended paths. For example, the hot combustion gases may leak into the interstage volume between rotor wheels 38, which may place thermal stresses on the turbine components. In certain embodiments, the interstage volume may be cooled by discharge air bled from the compressor 18 or provided by another source. However, flow of hot combustion gases into the interstage volume may abate the cooling effects. Accordingly, the interstage seal systems 42 may be disposed between adjacent rotor wheels 38 to seal and enclose the interstage volume from the hot combustion gases. In addition, the interstage seal systems 42 may be configured to direct a cooling fluid to the interstage volume or from the interstage volume toward the blades 36.

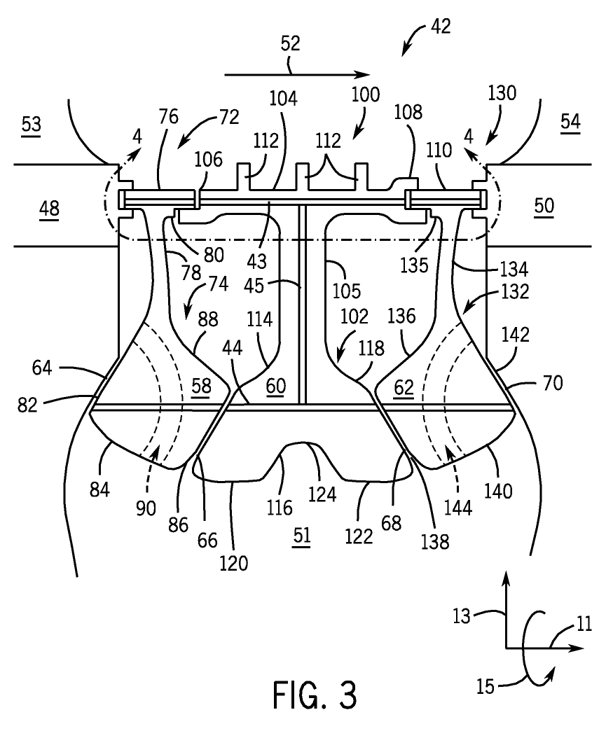

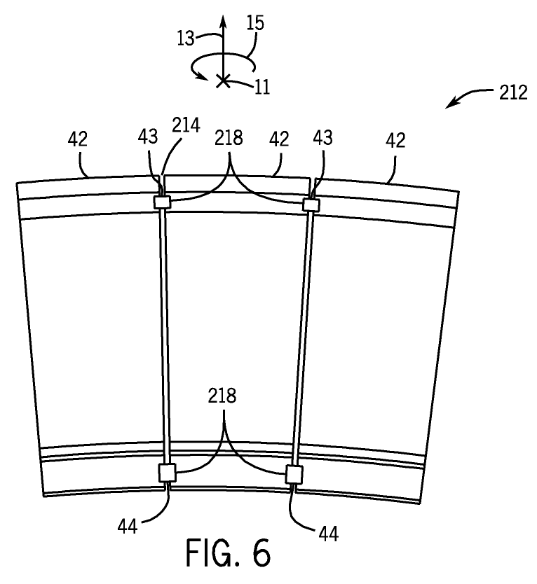

FIG. 3 is a partial cross-sectional side view of the gas turbine engine 12 illustrating an embodiment of the interstage seal system 42 between two turbine stages. The interstage seal system 42 extends longitudinally from an upstream rotor wheel 48 to a downstream rotor wheel 50. The interstage seal system 42 is disposed in a rotor cavity 51 between the upstream and downstream rotor wheels 48, 50. The interstage seal system 42 includes elements to reduce leakage of hot gas through unintended paths. These elements may include an outer seal 43, an inner seal 44, and a central seal 45, as discussed later in FIG. 6. As illustrated, the rotor cavity 51 is unobstructed by a spacer component (e.g. a mid-rotor support). Thus, internal components of the rotor may be more easily accessed compared to a rotor that includes a mid-rotor support, such as a spacer. Further, the axial components of the interstage seal system 42 may be field maintainable and replaceable in the field.

When the gas turbine engine 12 is in operation, hot gas may flow through the turbine 22 and generally take a path as indicated by arrow 52. More specifically, the hot gas may flow across a first, upstream turbine blade or bucket 53 attached to the upstream rotor wheel 48 and a second, downstream turbine blade or bucket 54 attached to the downstream rotor wheel 50. However, a portion of the hot gas may attempt to flow into the rotor cavity 51. Hot gas leakage into the rotor cavity 51 may decrease the efficiency of the turbine 22. Thus, the interstage seal system 42 may be designed to reduce hot gas leakage into the rotor cavity 51 and to maximize the main hot gas flow along arrow 52. Certain embodiments of the turbine 22 may route a cooling fluid, such as air, into the rotor cavity 51. The cooling fluid may reduce the temperature of various internal components of the rotor cavity 51. In such embodiments, the interstage seal system 42 may also reduce the leakage of cooling fluid into the hot gas flow path.

As shown, the interstage seal system 42 is formed by three constituent pieces that are coupled together in the axial direction 11. The constituent pieces are designed to reduce the magnitude or likelihood of radial and/or axial movement of the interstage seal system 42 with respect to the upstream and downstream rotor wheels 48, 50. The three constituent pieces include a forward coverplate 58, an interstage seal 60, and an aft coverplate 62. The forward coverplate 58 is axially coupled to the upstream rotor wheel 48 and the interstage seal 60. The interstage seal 60 is axially coupled to the forward coverplate 58 and the aft coverplate 62. Lastly, the aft coverplate 62 is axially coupled to the interstage seal 60 and the downstream rotor wheel 50.

In certain embodiments, the number of constituent pieces of the interstage seal system 42 may vary. For example, an embodiment of the interstage seal system 42 may include two constituent pieces that are coupled together in the axial direction 11. By way of example, such an embodiment may include only the forward coverplate 58 and the interstage seal 60. Another embodiment of the interstage seal system 42 may include four constituent pieces axially coupled together: the forward coverplate 58, the interstage seal 60, the aft coverplate 62, and an additional interstage seal (not shown). In general, the interstage seal system 42 may include 2, 3, 4, 5, 6, or more constituent pieces that are coupled together in the axial direction 11. The constituent pieces of the interstage seal system 42 may be field replaceable, which may allow easier and faster field maintenance.

As illustrated, the forward coverplate 58 may be wedged between the upstream rotor wheel 48 and the interstage seal 60. The upstream rotor wheel 48 and the interstage seal 60 may reduce the likelihood of axial movement of the forward coverplate 58. In certain embodiments, as described in greater detail below, the forward coverplate 58 may include elements, such as a hook assembly, to axially constrain the forward coverplate 58. As may be appreciated, other embodiments may include a combination of the hook assembly and/or other elements to axially constrain the forward coverplate 58. As shown, a wedged surface 64 of the upstream rotor wheel 48 abuts a side 82 (e.g., a mating side) of the forward coverplate 58 when the interstage seal system 42 is installed between the upstream and downstream rotor wheels 48, 50. In particular, a substantial portion of the side 82 (e.g., interface length) of the forward coverplate 58 (e.g., approximately 50 to 95, approximately 60 to 90, or approximately 60, 75, or 90 percent of the side 82) abuts the upstream rotor wheel 48. In certain embodiments, the interface length may vary based at least partially on the materials of the interstage seal system 42, the thermal or mechanical environment of the gas turbine engine 12, or a combination thereof. The wedged surface 64 extends in the circumferential direction 15. Additionally, in certain embodiments, the wedged surface 64 may extend from a radial centerline of the upstream rotor wheel 48 at approximately a 45 degree angle, as illustrated. Although, in other embodiments, the angle of the wedged surface 64 may be within a range of approximately 35 degrees and approximately 55 degrees. As may be appreciated, the angle of the wedged surface 64 may be optimized to meet stress specifications or other design goals of the interstage seal system 42.

A first wedged surface 66 of the interstage seal 60 abuts a side 86 (e.g., a mating side) of the forward coverplate 58 when the interstage seal system 42 is installed between the upstream and downstream rotor wheels 48, 50. The wedged surface 66 also extends in the circumferential direction 15. As illustrated, the wedged surfaces 64, 66 may be generally parallel to each other. The wedged surfaces 64, 66 are disposed at opposite axial ends of the forward coverplate 58. As a result, the wedged surfaces 64, 66 axially and/or radially constrain the forward coverplate 58 and reduce the likelihood of movement in the axial direction 11 and/or the radial direction 13.

The interstage seal 60 may be wedged between the forward coverplate 58 and the aft coverplate 62. Thus, the forward and aft coverplates 58, 62 may axially constrain the interstage seal 60. In certain embodiments, the interstage seal 60 may be press fit against the forward and aft coverplates 58, 62. The interstage seal 60 abuts the wedged surface 66 of the forward coverplate 58 when the interstage seal system 42 is installed between the upstream and downstream rotor wheels 48, 50, as described previously. In addition, a second wedged surface 68 of the interstage seal 60 abuts a side 138 (e.g., a mating side) of the aft coverplate 62 when the interstage seal system 42 is installed between the upstream and downstream rotor wheels 48, 50. The wedged surface 68 extends in the circumferential direction 15. Additionally, the wedged surface 68 is crosswise to the axial direction 11 and the radial direction 13. In certain embodiments, the wedged surfaces 66, 68 may have a similar shape. Further, the wedged surfaces 66, 68 may be symmetrical about the interstage seal 60 with respect to a radial centerline of the interstage seal 60. As illustrated, the wedged surfaces 66, 68 are disposed at opposite axial ends of the interstage seal 60. Thus, the wedged surfaces 66, 68 reduce the magnitude or likelihood of axial and/or radial movement of the interstage seal 60.

The aft coverplate 62 is wedged between the interstage seal 60 and the downstream rotor wheel 50. Thus, the interstage seal 60 and the downstream rotor wheel 50 axially and radially constrain the aft coverplate 62. In certain embodiments, as described in greater detail below, the aft coverplate 62 may include elements, such as a hook assembly, to axially constrain the aft coverplate 62. As may be appreciated, other embodiments may include a combination of the hook assembly and/or other elements to axially constrain the aft coverplate 62. As described previously, the aft coverplate 62 abuts the wedged surface 68 of the interstage seal 60 when the interstage seal system 42 is installed between the upstream and downstream rotor wheels 48, 50. In addition, a wedged surface 70 of the downstream rotor wheel 50 abuts a side 142 (e.g., a mating side) of the aft coverplate 62 when the interstage seal system 42 is installed between the upstream and downstream rotor wheels 48, 50. In particular, a substantial portion of the side 142 of the aft coverplate 62 (e.g., approximately 50 to 95, approximately 60 to 90, or approximately 60, 75, or 90 percent of the side 142) abuts the downstream rotor wheel 50. The wedged surface 70 extends in the circumferential direction 15. Additionally, in certain embodiments, the wedged surface 70 may extend from a radial centerline of the downstream rotor wheel 50 at approximately a 45 degree angle, as illustrated. Although, in other embodiments, the angle of the wedged surface 70 may be within a range of approximately 35 degrees and approximately 55 degrees. As illustrated, the wedged surfaces 68, 70 may be generally parallel to each other. The wedged surfaces 68, 70 are disposed at opposite axial ends of the aft coverplate 62. As a result, the wedged surfaces 68, 70 axially and/or radially constrain the aft coverplate 62 and reduce the likelihood of movement in the axial direction 11 and/or the radial direction 13.

The shapes of the forward coverplate 58, the interstage seal 60, and the aft coverplate 62 are designed such that the wedged surfaces 64, 66, 68, 70 axially and radially constrain the interstage seal system 42. As shown, the forward coverplate 58 has a relatively complex shape that includes an upper body 72 and a lower body 74. The upper body 72 is substantially T-shaped, and the lower body 74 is substantially rectangular with rounded edges. In other embodiments, the shapes of the upper body 72 and the lower body 74 may vary. For example, in certain embodiments, the lower body 74 may be circular. As may be appreciated, the shape of the forward coverplate 58 may be implementation-specific and may vary among embodiments.

The upper body 72 of the forward coverplate 58 includes a sealing portion 76 and a neck portion 78. As illustrated, the sealing portion 76 is substantially rectangular in shape, and extends generally parallel in the axial direction 11. The neck portion 78 is also substantially rectangular in shape. As illustrated, the neck portion 78 extends in the radial direction 13 from the sealing portion 76 to the lower body 74. In general, the neck portion 78 terminates at a corner of the generally rectangular shape of the lower body 74. In certain embodiments, the neck portion 78 may include a small support 80 that is designed to mate with the interstage seal 60. In other embodiments, the forward coverplate 58 may not include the neck portion 78. In such an embodiment, the lower body 74 may be disposed directly adjacent to the sealing portion 76.

The lower body 74 of the forward coverplate 58 includes four sides 82, 84, 86, 88. In the illustrated embodiment, each of the sides 82, 84, 86, 88 are substantially straight. However, in other embodiments, the shapes of the sides 82, 84, 86, 88 may vary. For example, the sides 82, 84, 86, 88 may be arcuate or include arcuate portions. Further, the number of sides of the lower body 74 may vary. For example, the lower body 74 may include 0, 1, 2, 3, 4, or more substantially straight sides and 0, 1, 2, 3, 4, or more arcuate sides. As described above, a portion of the side 82 abuts a portion of the wedged surface 64 of the upstream rotor wheel 48. The shape of the wedged surface 64 of the upstream rotor wheel 48 generally corresponds to the shape of the side 82 of the forward coverplate 58. Similarly, as described above, a portion of the side 86 abuts the wedged surface 66 of the interstage seal 60. The shape of the wedged surface 66 of the interstage seal 60 generally corresponds to the shape of the side 86 of the forward coverplate 58. As shown, in certain embodiments, the forward coverplate 58 also includes an interior passage 90. The interior passage 90 extends from the side 84 of the forward coverplate 58 to the side 82 of the forward coverplate 58. In certain embodiments, the interior passage 90 may route cooling fluids to the rotor cavity 51, a disk rim, and the buckets 53, 54.

The interstage seal 60 also has a relatively complex shape. The interstage seal 60 includes an upper body 100 and a lower body 102. As shown, the upper body 100 is substantially T-shaped and the lower body 102 is substantially triangular. In other embodiments, the general shapes of the upper body 100 and the lower body 102 may vary. For example, in certain embodiments, the lower body 102 may be circular. As may be appreciated, the shape of the interstage seal 60 may be implementation-specific and may vary among embodiments.

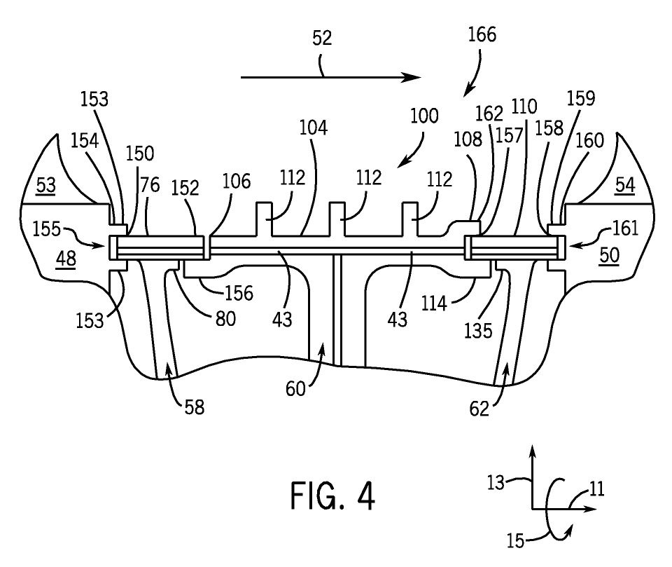

The upper body 100 of the interstage seal 60 includes a sealing portion 104 and a neck portion 105. As illustrated, the sealing portion 104 is substantially rectangular in shape, and extends generally parallel in the axial direction 11. In addition, the sealing portion 104 includes a forward arm 106 and an aft arm 108. In certain embodiments, the forward arm 106 may be designed to mate with the sealing portion 76 of the forward coverplate 58. Additionally, the aft arm 108 may be designed to mate with a sealing portion 110 of the aft coverplate 62. The sealing portions 76, 104, 110 isolate the rotor cavity 51 from hot gas flow 52 and will be discussed further with respect to FIG. 4. Further, the sealing portion 110 includes sealing teeth 112, which may contribute to the sealing ability of sealing portion 104. The sealing teeth 112 extend radially outward from the sealing portion 104.

The lower body 102 of the interstage seal 60 includes three sides (e.g., mating sides) 114, 116, and 118 arranged in a generally triangular shape. As may be appreciated, the general arrangement of the sides 114, 116, 118 may vary with the shape of the lower body 102. For example, an embodiment may include the lower body 102 with four sides arranged in a generally rectangular shape. As shown, a portion of the side 114 forms a portion of the wedged surface 66 of the interstage seal 60. In particular, a substantial portion of the side 86 of the forward coverplate 58 (e.g., approximately 50 to 99, approximately 75 to 95, or approximately 80, 85, 90, or 95 percent of the side 86) abuts the side 114 of the interstage seal 60. Similarly, a portion of the side 118 forms a portion of the other wedged surface 68 of the interstage seal 60. In particular, a substantial portion of a side 138 of the aft coverplate 62 (e.g., approximately 50 to 99, approximately 75 to 95, or approximately 80, 85, 90, or 95 percent of the side 138) abuts the side 118 of the interstage seal 60. The side 116 has a relatively complex shape that includes two leg portions 120, 122. As illustrated, the leg portions 120, 122 are substantially straight. The side 116 also includes an arcuate portion 124 that extends between the leg portions 120, 122. In other embodiments, the shapes of sides 114, 116, and 118 may vary.

The aft coverplate 62 also has a relatively complex shape that may be similar to the relatively complex shape of the forward coverplate 58. In particular, in certain embodiments, the aft coverplate 62 may be symmetrical with the forward coverplate 58 about a radial centerline of the interstage seal 60. However, in certain embodiments, the aft coverplate 62 may have a different shape compared to the forward coverplate 58. As illustrated, the aft coverplate 62 includes an upper body 130 and a lower body 132. The upper body 130 is substantially T-shaped, and the lower body 132 is substantially rectangular with rounded edges. In other embodiments, the shapes of the upper body 130 and the lower body 132 may vary. For example, in certain embodiments, the lower body 132 may be circular. As may be appreciated, the shape of the aft coverplate 62 may be implementation-specific and may vary among embodiments.

The upper body 130 of the aft coverplate 62 includes the sealing portion 110 and a neck portion 134. As illustrated, the sealing portion 110 is substantially rectangular in shape, and extends generally parallel in the axial direction 11. The neck portion 134 is also substantially rectangular in shape. As illustrated, the neck portion 134 extends in the radial direction 13 from the sealing portion 110 to the lower body 132. In general, the neck portion 134 terminates at a corner of the generally rectangular shape of the lower body 132. In certain embodiments, the neck portion 134 may include a small support 135 that is designed to mate with the interstage seal 60. In certain embodiments, the aft coverplate 62 may not include the neck portion 134. In such an embodiment, the lower body 132 may be disposed directly adjacent to the sealing portion 110.

The lower body 132 of the aft coverplate 62 includes four sides 136, 138, 140, 142. In the illustrated embodiment, each of the sides 136, 138, 140, 142 are substantially straight. However, in other embodiments, the shapes of the sides 136, 138, 140, 142 may vary. For example, the sides 136, 138, 140, 142 may be arcuate or include arcuate portions. Further, the number of sides of the lower body 132 may vary. For example, the lower body 132 may include 0, 1, 2, 3, 4, or more substantially straight sides and 0, 1, 2, 3, 4, or more arcuate sides. As described above, a portion of the side 138 abuts a portion of the wedged surface 68 of the interstage seal 60. The shape of the wedged surface 68 of the interstage seal 60 generally corresponds to the shape of the side 138. Similarly, as described above, a portion of the side 142 abuts the wedged surface 70 of the downstream rotor wheel 50. The shape of the wedged surface 70 of the downstream rotor wheel 50 generally corresponds to the shape of the side 142. As shown, in certain embodiments, the aft coverplate 62 also includes an interior passage 144. The interior passage 144 extends from the side 140 of the aft coverplate 62 to the side 142 of the after coverplate 62. In certain embodiments, the interior passage 144 routes cooling fluids to various regions of the rotor cavity 51.

FIG. 4 is a partial cross-sectional side view of an embodiment of interstage seal system 42 of FIG. 3 illustrating the sealing portions 76, 104, and 110. The sealing portion 76 of the forward coverplate 58 includes an upstream arm 150 and a downstream arm 152. As shown, the upstream arm 150 is designed to rest within a support 154 of the upstream rotor wheel 48 or bucket 53. In certain embodiments, the support 154 includes two protruding portions 153 that extend axially from the upstream rotor wheel 48 or bucket 53 towards the forward coverplate 58. The upstream arm 150 of the forward coverplate 58 is configured to fit within a groove 155 (e.g., between the two protruding portions 153) of the support 154 of the upstream rotor wheel 48 or bucket 53. As such, the support 154 may reduce the likelihood or magnitude of radial movement of the forward coverplate 58. Similarly, the downstream arm 152 of the forward coverplate 58 is designed to rest on a support 156 of the forward arm 106 of the interstage seal 60, which extends axially from the interstage seal 60 towards the forward coverplate 58. In particular, the shape of the support 156 of the interstage seal 60 may be designed such that the downstream arm 152 of the forward coverplate 58 is supported radially by the support 156. Additionally, the shape of the support 80 of the forward coverplate 58 is designed to accommodate the support 156 of the interstage seal 60. Further, the support 156 may radially retain the forward coverplate 58 during installation.

The sealing portion 110 of the aft coverplate 62 also includes an upstream arm 157 and a downstream arm 158. As shown, the downstream arm 158 is designed to rest within a support 160 of the downstream rotor wheel 50 or bucket 54. In certain embodiments, the support 160 includes one or more protruding portions 159 that extend axially from the downstream rotor wheel 50 or bucket 54 towards the aft coverplate 62. The downstream arm 158 of the aft coverplate 62 is configured to fit within a groove 161 of the support 160 of the downstream rotor wheel 50 or bucket 54. As such, the support 160 may reduce the likelihood or magnitude of radial movement of the aft coverplate 62. Similarly, the upstream arm 157 of the aft coverplate 62 is designed to rest between two supports 162, 164 of the aft arm 108 of the interstage seal 60. The supports 162, 164 extend axially from the interstage seal 60 towards the aft coverplate 62. In particular, the shape of the supports 162, 164 of the interstage seal 60 may be designed such that the upstream arm 157 of the aft coverplate 62 is supported radially by the supports 162, 164. Additionally, the shape of the support 135 of the aft coverplate 62 is designed to accommodate the support 164 of the interstage seal 60.

In certain embodiments, the aft coverplate 62 may be radially supported or captured by the bucket 54. For example, the forward coverplate 58, interstage seal 60, and aft coverplate 62 may be held in place, and the bucket 54 may be adjusted in the axial direction 11 to lock the interstage seal system 42 in place. More specifically, the forward coverplate 58 may be held in place and captured by the protruding portions 153 of the upstream rotor wheel 48 or bucket 53. The interstage seal 60 and aft coverplate 62 may be lowered into the cavity 51, and the aft coverplate 62 may be moved towards the shaft 26 (e.g., centerline of the turbine 22) and hooked into the aft arm 108 of the interstage seal 60. The aft coverplate 62 and the interstage seal 60 may be raised into position, and the bucket 54 may be moved axially 11 to capture the interstage seal system 42 in place.

During normal operation of the turbine 22, hot gas may take a general flow path as shown by the arrow 52. The sealing portions 76, 104, 110 isolate the hot gas flow path from the rotor cavity 51. In particular, the sealing portions 76, 104, 110 form an upper seal 166 of the interstage seal system 42. The upper seal 166 reduces the likelihood or magnitude of hot gas flow into the rotor cavity 51. Furthermore, in an embodiment including cooling fluids in the rotor cavity 51, the upper seal 162 reduces the likelihood or magnitude of cooling fluid flow into the hot gas flow path. The upper seal 166 may be complemented by the outer seal 43, as described later in FIG. 6.

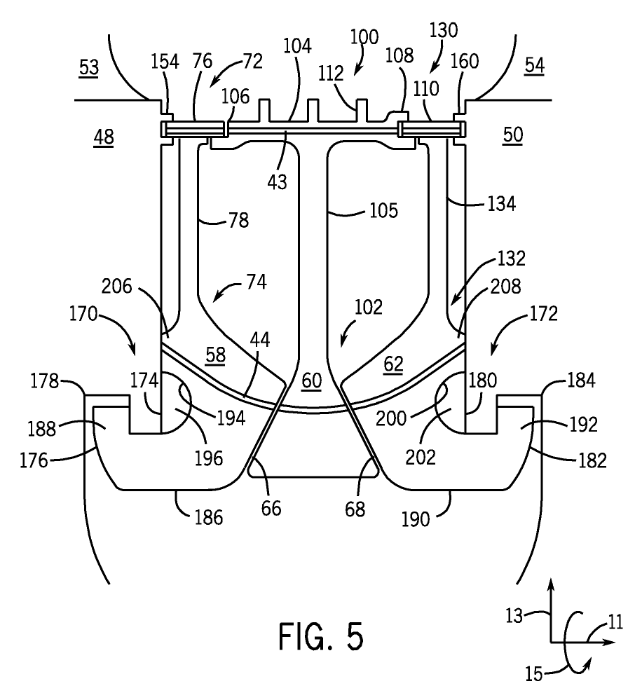

FIG. 5 is a partial cross-sectional side view of the gas turbine engine 12 illustrating another embodiment of the interstage seal system 42 between two turbine stages. The interstage seal system 42 includes the forward coverplate 58, the interstage seal 60, and the aft coverplate 62. As described previously, the interstage seal system 42 is designed such that the forward coverplate 58, the interstage seal 60, and the aft coverplate 62 may be field maintainable and field replaceable. As illustrated, the interstage seal 60 may be wedged between the forward coverplate 58 and the aft coverplate 62, similar to the embodiment illustrated in FIG. 3. Again, the wedged surface 66 of the interstage seal 60 abuts the forward coverplate 58, and the wedged surface 68 of the interstage seal 60 abuts the aft coverplate 62. Further, portions of the interstage seal system 42 may be supported radially by the sealing portions 76, 106, and 110, as described previously with respect to FIG. 4.

In the embodiment illustrated in FIG. 5, the interstage seal system 42 includes an upstream hook assembly 170 and a downstream hook assembly 172. The upstream and downstream hook assemblies 170, 172 axially and radially constrain the interstage seal system 42. The upstream hook assembly 170 includes an upstream hook support 174 disposed at the upstream rotor wheel 48 or bucket 53. Additionally, the upstream hook assembly 170 includes a hook end 176 of the forward coverplate 58. The hook end 176 is designed to fit into a radial groove 178 of the upstream rotor wheel 48 or bucket 53. The radial groove 178 is in an upstream position relative to the hook support 174. Similarly, the downstream hook assembly 172 includes a downstream hook support 180 disposed at the downstream rotor wheel 50 or bucket 54. Additionally, the downstream hook assembly 172 includes a hook end 182 of the aft coverplate 62. The hook end 182 is designed to fit into a radial groove 184 of the downstream rotor wheel 50 or bucket 54. As illustrated, the radial groove 184 is in a downstream position relative to the hook support 180.

The forward and aft coverplates 58, 62 have relatively complex shapes to accommodate the hook ends 176, 182. Generally, the forward coverplate 58 may include a base 186. A protrusion 188 of the hook end 176 extends radially crosswise relative to the base 186. The protrusion 188 is designed to fit into the radial groove 178 of the upstream rotor wheel 48. Additionally, the protrusion 188 may abut the hook support 174. Similarly, the aft coverplate 62 may include a base 190. A protrusion 192 of the hook end 182 extends radially crosswise relative to the base 190. The protrusion 192 is designed to fit into the radial groove 184 of the downstream rotor wheel 50. Further, the protrusion 192 may abut the hook support 180.

The forward coverplate 58 includes a concave portion 194 disposed radially between the neck portion 78 and the base 186. The concave portion 194 forms a hollow region 196 between the upstream rotor wheel 48 and the concave portion 194. Similarly, the aft coverplate 62 includes a concave portion 200. The concave portion 200 may form a hollow region 202 between the downstream rotor wheel 50 and the concave portion 200.

As illustrated, the forward and aft coverplates 58, 62 may also include protruding portions 206, 208 that abut the upstream and downstream rotor wheels 48, 50, respectively. The protruding portion 206 of the forward coverplate 58 is directly adjacent the concave portion 194 and the neck portion 78 of the forward coverplate 58, and the protruding portion 208 of the aft coverplate 62 is directly adjacent the concave portion 200 and the neck portion 134 of the aft coverplate 62. The protruding portions 206, 208 of the forward and aft coverplates 58, 62 further stabilize the interstage seal system 42 between the upstream and downstream rotor wheels 48, 50.

The interstage seal system 42 also includes the outer seal 43 and the inner seal 44. As shown, the inner seal 44 extends from the upstream rotor wheel 48 to the downstream rotor wheel 50 through the forward coveplate 58, interstage seal 60, and aft coverplate 62. The outer seal 43 extends from the support 154 of the upstream rotor wheel 48 or bucket 53 to the support 160 of the downstream rotor wheel 50 or bucket 54. The function of the outer and inner seals 43, 44 will be explained further in FIG. 6. As illustrated, the outer seal 43 may be a rectangular seal, and the inner seal 44 may be a rope seal. As may be appreciated, a rope seal may have lower stress than a rectangular seal. In certain embodiments, the sealing mechanisms of the outer and inner seals 43, 44 may vary. For example, both of the outer and inner seals 43, 44 may be a rectangular seal.

FIG. 6 is a side view of three substantially identical, circumferentially adjacent interstage seal systems 42. FIG. 6 illustrates how adjacent sections of the interstage seal systems 42 may be attached together to form seals between adjacent stages of the gas turbine engine 12. The three interstage seals systems 42 may form a portion of a seal assembly 212. The seal assembly 212 may include multiple interstage seal systems 42 disposed adjacent to one another to form a 360-degree ring about the shaft 26 of the gas turbine engine 12. The number of interstage seal systems 42 that form the seal assembly 212 may range from approximately 2 to 100, or 10 to 80, or 42 to 50 in certain embodiments. As shown, each of the interstage seal systems 42 is arcuate in the circumferential direction 15. Thus, in certain embodiments, a gap 214 may exist between adjacent interstage seal systems 42. The seal assembly 212 may include the outer seals 43 and the inner seals 44 disposed in the gaps 214 between interstage seal systems 42. As illustrated, the outer seal 43 may be disposed circumferentially between the upper bodies of interstage seal systems 42, and the inner seal 44 may be disposed between the lower bodies of interstage seal systems 42. The outer seals 43 and the inner seals 44 reduce the likelihood or impact of radial gas leakage through the gaps 214. In certain embodiments, axial slots 218 may be formed in the interstage seal system 42 to accommodate the outer seals 43 and the inner seals 44. In certain embodiments, the outer seal 43 or the inner seal 44 may be disposed along different regions of the interstage seal system 42. In addition, the seal assembly 212 may include a different number or a different arrangement of outer seals 43 and/or inner seals 44. For example, a seal assembly 212 may include 1, 2, 3, or 4 or more outer seals 43 disposed between each adjacent pair of interstage seal systems 42. In addition, the seal assembly 212 may not include the inner seals 44.

Technical effects of the disclosed embodiments include an interstage seal system for reducing radial leakage between stages of a turbine. The interstage seal system includes features to seal an interstage gap without the use of additional components, such as spacer wheels. The interstage seal system includes multiple axial components that are designed to wedge against each other. The wedged surfaces formed between the multiple axial components reduce the likelihood or magnitude of axial or radial displacement of the interstage seal system. Furthermore, the axial components of the interstage seal system may be field maintainable and replaceable in the field.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a multi-stage turbine, comprising:
an interstage seal system extending axially between a first turbine stage of the multi-stage turbine and a second turbine stage of the multi-stage turbine, wherein the interstage seal system comprises:
an interstage seal;
a forward coverplate disposed axially between a first rotor wheel of the first turbine stage and the interstage seal; and
an aft coverplate disposed axially between the interstage seal and a second rotor wheel of the second turbine stage, wherein the interstage seal is configured to wedge axially between the forward and aft coverplates.

2. The system of claim 1, wherein the interstage seal comprises a T-shaped upper body comprising a generally rectangular seal portion that extends generally parallel to a shaft of the multi-stage turbine, and a neck portion that extends radially from seal portion toward the shaft of the multi-stage turbine, and a generally triangular shaped lower body, wherein the neck portion of the upper body terminates at a corner of the generally triangular shaped lower body.

3. The system of claim 2, wherein the forward and aft coverplates each comprise a T-shaped upper body comprising a generally rectangular seal portion that extends generally parallel to a shaft of the multi-stage turbine, and a neck portion that extends radially from the seal portion toward the shaft of the multi-stage turbine, and a generally rectangular shaped lower body, wherein the neck portion of the upper body terminates at a corner of the generally rectangular shaped lower body.

4. The system of claim 3, wherein a substantial portion of a side of the generally rectangular shaped lower bodies of the forward and aft coverplates abuts a mating side of the generally triangular shaped lower body of the interstage seal.

5. The system of claim 3, wherein a substantial portion of a side of the generally rectangular shaped lower body of the forward coverplate abuts the first rotor wheel of the first turbine stage, and a substantial portion of a side of the generally rectangular shaped lower body of the aft coverplate abuts the second rotor wheel of the second turbine stage.

6. The system of claim 3, wherein a first end of the seal portion of the upper body of the forward coverplate is disposed within a groove in the first rotor wheel of the first turbine stage, and a first end of the seal portion of the upper body of the aft coverplate is disposed within a groove in the second rotor wheel of the second turbine stage.

7. The system of claim 6, wherein a second end of the seal portion of the upper body of the aft coverplate is disposed within a groove in a first end of the seal portion of the interstage seal, and a second end of the seal portion of the upper body of the forward coverplate rests on a support at a second end of the seal portion of the interstage seal.

8. The system of claim 2, wherein the forward and aft coverplates each comprise a T-shaped upper body comprising a generally rectangular seal portion that extends generally parallel to the shaft of the multi-stage turbine, and a neck portion that extends radially from seal portion toward the shaft of the multi-stage turbine, and a generally C-shaped lower body.

9. The system of claim 8, wherein the generally C-shaped lower body of the forward coverplate comprises a generally rectangular shaped hook end protrusion disposed within a generally rectangular shaped groove in the first rotor wheel of the first turbine stage, and the generally C-shaped lower body of the aft coverplate comprises a generally rectangular shaped hook end protrusion disposed within a generally rectangular shaped groove in the second rotor wheel of the second turbine stage.

10. The system of claim 2, wherein the seal portion of the interstage seal comprises a plurality of sealing teeth on a radially outward side of the seal portion.

11. A system, comprising:
an interstage seal system axially between a first rotor wheel of a first turbine stage of a multi-stage turbine and a second rotor wheel of a second turbine stage of the multi-stage turbine, wherein the interstage seal system comprises:
an interstage seal; and
at least one coverplate, wherein the interstage seal is configured to wedge axially between the at least one coverplate and the first or second rotor wheel.

12. The system of claim 11, wherein the at least one coverplate is axially and radially constrained to the first or second rotor wheel with a hook end.

13. The system of claim 11, wherein the at least one coverplate comprises a forward coverplate disposed axially between the first rotor wheel of the first turbine stage and the interstage seal.

14. The system of claim 11, wherein the at least one coverplate comprises an aft coverplate disposed axially between the interstage seal and the second rotor wheel of the second turbine stage.

15. The system of claim 11, wherein the at least one coverplate includes an interior passage configured to route a cooling fluid between the first and second rotor wheels.

16. The system of claim 11, wherein the interstage seal comprises a T-shaped upper body comprising a generally rectangular seal portion that extends generally parallel to a shaft of the multi-stage turbine, and a neck portion that extends radially from the seal portion of the interstage seal toward the shaft of the multi-stage turbine, and a generally triangular shaped lower body, wherein the neck portion of the upper body of the interstage seal terminates at a corner of the generally triangular shaped lower body of the interstage seal.

17. The system of claim 16, wherein the at least one coverplate comprises a T-shaped upper body comprising a generally rectangular seal portion that extends generally parallel to the shaft of the multi-stage turbine, and a neck portion that extends radially from the seal portion of the at least one coverplate toward the shaft of the multi-stage turbine, and a generally rectangular shaped lower body, wherein the neck portion of the upper body of the at least one coverplate terminates at a corner of the generally rectangular shaped lower body of the at least one coverplate.

18. The system of claim 17, wherein a substantial portion of a side of the generally rectangular shaped lower body of the at least one coverplate abuts a mating side of the generally triangular shaped lower body of the interstage seal.

19. The system of claim 17, wherein a substantial portion of a side of the generally rectangular shaped lower body of the at least one coverplate abuts the first or second rotor wheel.

20. A system, comprising:
a multi-stage turbine, comprising:
an interstage seal system extending axially between a first turbine stage of the multi-stage turbine and a second turbine stage of the multi-stage turbine, wherein the interstage seal system comprises:
an interstage seal having a T-shaped upper body comprising a generally rectangular seal portion that extends generally parallel to a shaft of the multi-stage turbine;
a forward coverplate disposed axially between a first rotor wheel of the first turbine stage and the interstage seal and having a T-shaped upper body comprising a generally rectangular seal portion that extends generally parallel to the shaft of the multi-stage turbine; and
an aft coverplate disposed axially between the interstage seal and a second rotor wheel of the second turbine stage and having a T-shaped upper body comprising a generally rectangular seal portion that extends generally parallel to the shaft of the multi-stage turbine;
wherein the interstage seal is configured to be captured by or to wedge axially between the forward and aft coverplates.
